(19) United States
(12) Patent Application Publication
(10) Pub. No.: US 2005/0231394 A1
(43) Pub. Date: Oct. 20, 2005

(54) Traffic information display apparatus

(75) Inventors: Kimiyoshi Machii, Hitachinaka-shi (JP); Yoshinori Endo, Mito-shi (JP); Kenichiro Yamane, Hitachi-shi (JP); Masatoshi Kumagai, Hitachi-shi (JP); Junsuke Fujiwara, Hitachi-shi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Chiyoda-ku (JP)

(21) Appl. No.: 11/063,556

(22) Filed: Feb. 24, 2005

(30) Foreign Application Priority Data
Feb. 25, 2004 (JP) 2004-048893

(51) Int. Cl. G08G 1/00; G06G 7/70; G06G 7/76; G06F 19/00; H04L 12/28; G08G 1/123

(52) U.S. Cl. 340/995.13; 701/117

(57) ABSTRACT

A traffic information display apparatus includes a unit for estimating traffic information relating to a link not included in data sent from a traffic information center. A terminal has a display control unit for changing a display method according to whether or not traffic information received from the information center is estimated data. Thereby traffic information distributed on a real time basis and traffic information statistical data can be displayed to be distinguished from each other, and the user can have a criterion of decision of validity of using the traffic information.

### CROSS-REFERENCE TO RELATED APPLICATION

This application relates to U.S. patent application Ser. No. 10/932,061 filed Sep. 2, 2004 entitled “TRAFFIC INFORMATION PROVIDING SYSTEM AND CAR NAVIGATION SYSTEM” by Kenichiro YAMANE et al., the disclosure of which is incorporated by reference.

### BACKGROUND OF THE INVENTION

The present invention relates to a system for providing traffic information.

Car navigation systems currently available in the market have a function of obtaining traffic information from outside of a vehicle. More specifically, such systems receives information distributed from a VICS (Vehicle Information and Communication System) with use of optical beacon, radio beacon, FM multiplex broadcast, etc. Such information is used to be displayed on the screen together with a map or for route search. For example, it is possible to draw a route so as to avoid a congested road. However, it is already known that there are many information missing links in the VICS.

JP-A-07-129893 discloses a technique by which a vehicle receives traffic information being transmitted from the outside of the vehicle and estimates a travel time of a link having traffic information not provided. More in detail, information can be provided even to such a no-information-provided link by estimating the travel time of the link in question from travel times of peripheral links, estimating it from links located upstream or downstream of the link in question, or estimating it on the basis of information at the time of the previous information reception.

JP-A-10-38597 discloses a technique by which a congestion link ratio in an area is used to estimate the cost of a link not provided with traffic information in the area. More specifically, when a congestion link ratio in the area is not smaller than a constant value, the link cost of the no-information-provided link in the area is increased to a predetermined value.

Even if traffic information about the no-information-provided link could be prepared in the above method, its reliability cannot be guaranteed. In other words, its accuracy cannot be necessarily guaranteed due to the algorithm used in the estimation of the no-information-provided link, frequent fluctuations of information about peripheral links used in the estimation, etc.

Even when a vehicle runs along a route computed by a car navigation system, the vehicle often runs into a congestion, in which case, the user must make a difficult choice between avoiding the route and going along the route. In such a case, when the estimated traffic information is displayed to be mixed with real-time information distributed as a traffic information distribution service, the user usually takes all the information displayed as accurate real-time information, because the user does not know the fact that traffic information are not provided to all links. And after the user arrives at the spot, the user can know the fact that the information was different from actual information about the spot. This results in the user being confused thereby.

### SUMMARY OF THE INVENTION

An object of the present invention is to provide a traffic information display apparatus which can display actually-received traffic information and statistical data of the traffic information so as to discriminate between them.

A traffic information center has a unit for estimating traffic information relating to a link and not included in data sent from the traffic information center, and the car terminal has a display control unit for changing a display method according to whether or not the traffic information received from the information center is the estimated data.

The display control unit displays the data of the traffic information center when displaying traffic information about a location close to the position of its own car terminal; whereas, displays processed traffic information when displaying traffic information about a location far away from the position of the car terminal.

The terminal has a memory unit for storing at least map information, site information and traffic information, and the memory unit previously stores at least statistically-processed traffic information therein.

In accordance with the present invention, traffic information distributed on a real time basis can be displayed to be distinguished from statistical data of the traffic information. For this reason, the user can have a criterion of decision of its use validity.

Other objects, features and advantages of the invention will become apparent from the following description of the embodiments of the invention taken in conjunction with the accompanying drawings.

### BRIEF DESCRIPTION OF THE DRAWINGS

FIG. 1 shows a general system of the present invention;

FIG. 2 shows a detailed configuration of a navigation server;

FIG. 3 is a processing flow chart of a car-mounted terminal;

FIG. 4 is a flow chart of operations of displaying traffic information in the car-mounted terminal;

FIG. 5 is a flow chart of operations of estimating traffic information about a link having no traffic information provided thereto;

FIG. 6 is a flow chart of operations of estimating traffic information about a link having no traffic information provided thereto;

FIG. 7 is a flow chart of operations of estimating traffic information about a link having no traffic information provided thereto;

FIG. 8 shows a link directional vector;

FIG. 9 is a menu display screen of the car-mounted terminal;

FIG. 10 is a display screen showing traffic information on the car-mounted terminal;

FIG. 11 is a display screen showing downloaded traffic information on the car-mounted terminal;

FIG. 12 is a display screen showing traffic information together with a route on the car-mounted terminal;

FIG. 13 is a sequence diagram of operations of downloading traffic information together with a route;

FIG. 14 is a flow chart of operations of changing traffic information according to a distance from the position of a car on the car-mounted terminal; and

FIG. 15 is an example of a software configuration of a navigation application.

### DETAILED DESCRIPTION OF THE EMBODIMENTS

An embodiment of the present invention will be described by referring to the attached drawings.

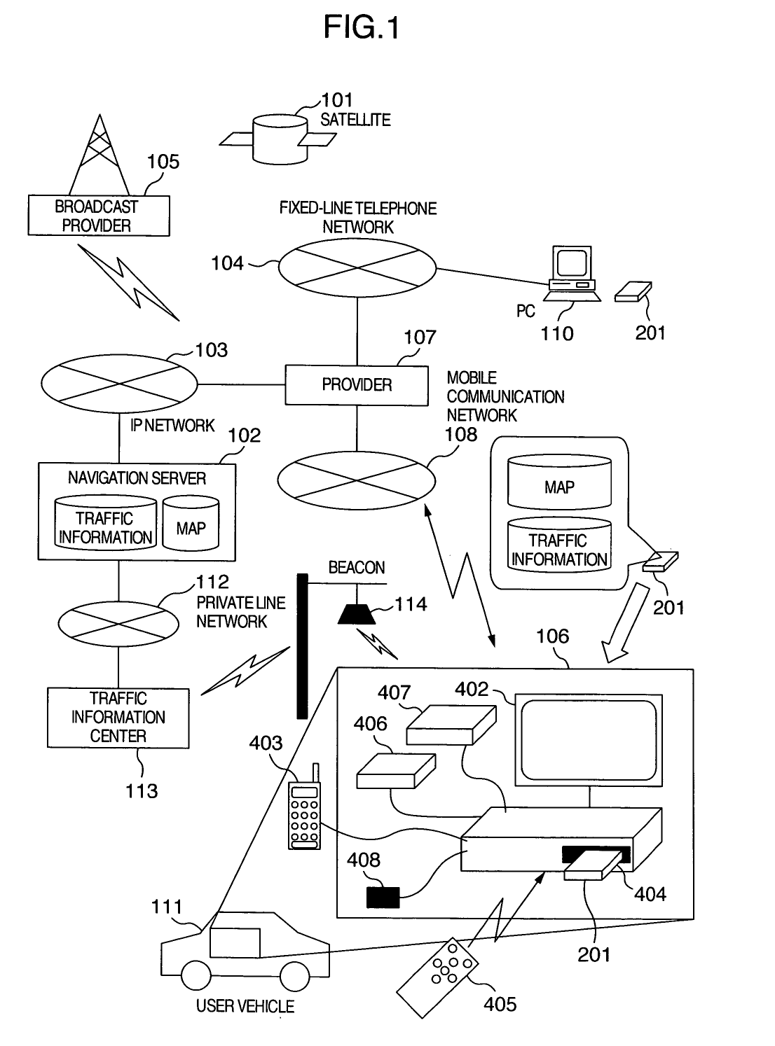

FIG. 1 shows a general system in accordance with the present invention. The system of the invention includes a satellite 101, a user vehicle 111 having a terminal 106 mounted therein, a mobile communication network 108, a provider 107 for establishing a connection with the Internet, a broadcast provider 105 for receiving data transmitted from the satellite and distributing the received data to the user via an IP network 103, a navigation server 102 for receiving and transmitting data from and from the provider 107, a fixed-line telephone network 104 connected with the provider 107 for performing data transfer via the IP network 103 or the mobile communication network 108, a beacon 114 for distributing traffic information to the user vehicle 111 on the road, each user's home 109, and a PC (Personal Computer) 110 provided in each user home. The navigation server 102 is connected with a traffic information center 113 via a private line network 112.

The car-mounted terminal 106 can acquire information by accessing the navigation server 102 via the fixed-line telephone network 104. Similarly, the PC 110 can acquire information by accessing the navigation server 102.

The navigation server 102 is equipped with a customer DB server for storing a route search engine, site information data about restaurants, convenient stores, etc., traffic information, and user information. The navigation server 102, in response to a request from the car-mounted terminal 106 or the PC 110, searches for information and returns it thereto. The navigation server 102 has a route search engine. The search engine executes a route search in the presence of a route search request from the car-mounted terminal 106 or the PC 110, returns its search result thereto, and stores it in the navigation server 102. Further, the route search result stored in the navigation server 102 can also be again used later. For example, the user can issue a route search request from the PC 110 at user's home, and when the user uses the vehicle, the user can download it using the car-mounted terminal 106 and execute route guidance.

The car-mounted terminal 106 has a car-mounted terminal main body 401, a display 402, a portable telephone 403, a memory card slot 404 provided in the car-mounted terminal main body 401, a remote controller 405, a GPS (Global Positioning System) receiver 406, a beacon receiver 407. In this case, the memory card slot 404 is used by inserting a memory card 201 into the slot. The memory card 201 uses, for example, a nonvolatile semiconductor memory, a small magnetic disk drive or the like.

The car-mounted terminal 106 establishes a dialup connection via the portable telephone 403 and accesses the IP network 103. In this case, a communication module (not shown) in place of the portable telephone 403 may be built in the car-mounted terminal main body 401. The GPS receiver 406, which is a device for measuring the position of the vehicle, can measure the latitude and longitude points of the car.

The beacon receiver 407 receives information from the beacon 114 during run of the user vehicle 111 along the road. Traffic information about links are being distributed from the beacon 114, and when the beacon receiver 407 receives such traffic information, the user can perform a route search to avoid a congestion.

Data on the car-mounted terminal 106 are stored in the memory card 201. The data stored in the memory card 201 includes mainly map information and traffic information. The traffic information includes statistical data of traffic information about nationwide roads, and statistical data of link travel times of nationwide links.

There are several methods of storing data in the memory card 201. First, the car-mounted terminal 106 is mounted in the user vehicle 111 and connected to the IP network 103. Thus, the user in the vehicle can obtain information. Further, since the navigation server 102 can also be accessed by the PC 110 installed in his home or by a private terminal (not shown) installed in a store such as a convenient store. Accordingly, data such as map and traffic information may be downloaded from the server via the store or home PC. In this case, the data is copied to the memory card 201, and the card is inserted into the car-mounted terminal 106 for its use.

A memory card 201 having simple map data, traffic information, or statistical traffic information previously stored therein may be purchased and inserted into the car-mounted terminal 106. In this case, the downloaded data may be overwritten or be stored in an area different from an area having the previously-stored data.

Another storage device may be used in combination with the memory card 201. For example, a hard disk may be previously built in to previously store necessary data. In this case, the data downloaded by the PC or the store private terminal can be used as another method, by storing the data in the memory card 201, inserting the card into the car-mounted terminal 106, and copying the data thereto. It is also possible to store the data downloaded by the car-mounted terminal 106 directly in the hard disk. Or on the road, the data may be downloaded by a portable telephone and previously stored in the memory card 201.

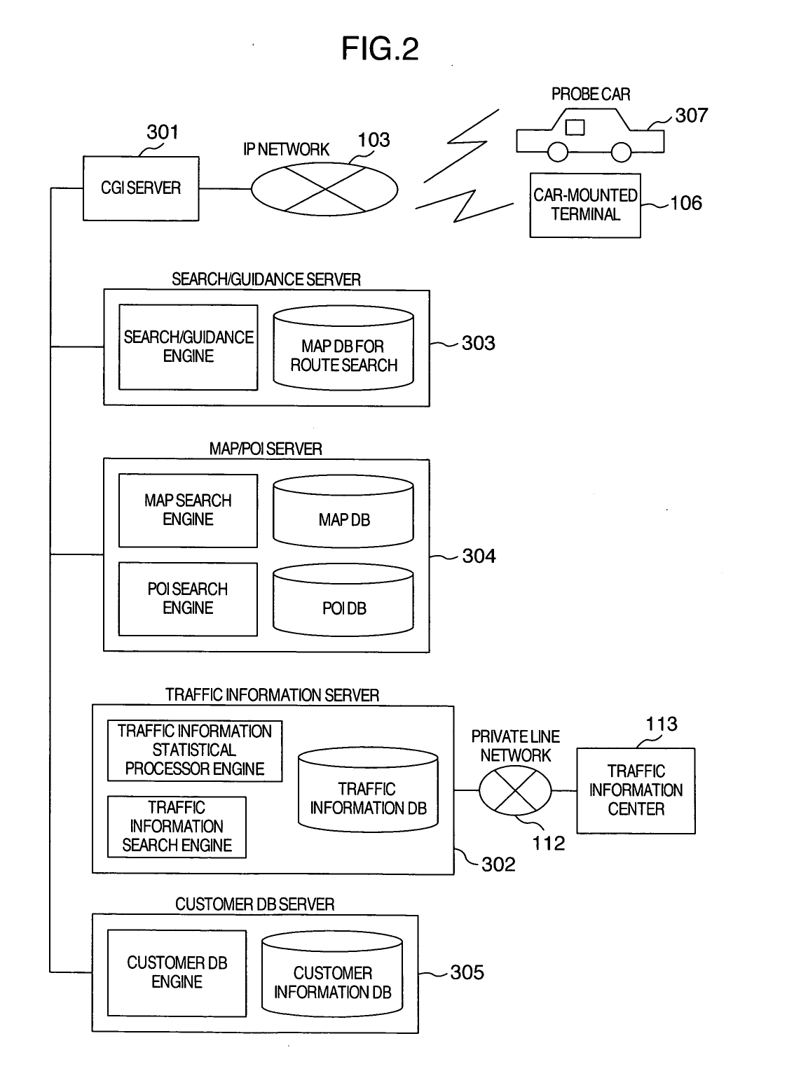

FIG. 2 is a detailed arrangement of the navigation server 102. The navigation server 102 is provided with a CGI (Common Gateway Interface) server 301, a traffic information server 302, a search/guidance server 303, a map/POI server 304, and a customer DB server 305.

The navigation server 102 receives, as data relating to a request service, latitude/longitude information, moving speed information, moving direction, ID number, and authentication password of the car-mounted terminal 106, engine rotational speed of the user vehicle 111, and other parameters indicative of states of the vehicle 111, sent via the IP network 103. Thereafter, the CGI server 301 implements user authentication, and then, in response to a user request service, transmits the data to the map/POI server 304, the search/guidance server 303, and the traffic information server 302 for its processing.

With respect to the data accepted by the respective servers, information relating to the user request service are sent to the car-mounted terminal 106 via the CGI server 301, the IP network 103, the provider 107, and the mobile communication network 108 (whose route will be referred to as the communication network, hereinafter). Or when the service information is transmitted by broadcast from the viewpoint of low cost; the data is transmitted to the car-mounted terminal 106 via the CGI server 301, the IP network 103, the broadcast provider 105, and the satellite 101 (whose route will be referred to as the broadcast network, hereinafter).

Explanation will next be made as to the functions of the above servers. The traffic information server 302, which processes traffic information, is provided with a traffic information search engine and a traffic information database. The server 302 is connected to the traffic information center 113 via the private line network 112. The traffic information server 302 can receive traffic information distributed from the traffic information center 113, process the received information, or distribute the information without being processed as it is. For example, the server 302 can distribute update data of the traffic information statistical data stored in the memory card 201. A link having information from the traffic information center 113 can be used as it is; whereas, a link not having such information can store traffic information statistical data. These data may be created, in response to a request from the car-mounted terminal 106, by the navigation server 102. To this end, data to be distributed from the navigation server 102 includes a flag to identify whether the data is from the traffic information center 113 or is the statistical traffic information data.

The traffic information center 113 has a function of collecting traffic information about Japan nationwide traffic and also has a function of distributing the traffic information. In general, car sensors are installed along a road at intervals of a distance, and a congestion is decided according to the detected states of the sensors. The congestion decision may also be made according to data of speed information uploaded from a probe car 207 running along the road. The traffic information server 302 has a function of processing data distributed from the traffic information center 113 and distributing it to the car-mounted terminal 106.

Information is distributed from the traffic information center 113 at intervals of a constant time. The distributed information includes at least travel times and degrees of congestion of links, and sometimes includes information about traffic regulation, parking lot, service area (SA)/parking area (PA). The traffic information server 302 distributes traffic information about the vicinity of the car-mounted terminal 106 by processing such information, or searches for traffic information on the road or about the vicinity of the route on the basis of a route-searched result, and distributes it. Of course, it is also possible to search for traffic information about the vicinity of a given site and distribute it.

The search/guidance server 303, which computes route/guidance information, is provided with a route search engine and a map for route search. After the user authentication by the CGI server 301, the route search engine creates a route coordinate point array, route link information and guidance point information on the basis of the departure point information, goal information, search conditions, other option data, etc. sent from the car-mounted terminal 106, by referring to the aforementioned map for route search.

The route-searched result is stored in the customer DB server 305, and when the DB server receives a request of on-the-road traffic information from the car-mounted terminal 106, the result is acquired from the traffic information server 302 and referred to. Such a result may be used when the DB server receives a route re-transmission request from the car-mounted terminal 106 or when the server divides the route into small segments and distributes them.

The customer DB server 305 is provided to store information relating to customers. In the DB server, not only person information but also an access history from the car-mounted terminal 106 and a searched route are stored for each user. The route information includes at least route point array and guidance point information. When route link information is stored, it can be used to extract on-the-road traffic information.

FIG. 15 shows a software configuration of a navigation application for vehicle navigation built in the car-mounted terminal 106. The navigation application includes a controller 3001, a traffic information processor 3004, a route/guidance information processor 3005, and a map information processor 3006. The controller 3001 has an application control 3002 and a display control 3003 as software modules.

The controller 3001 is a module for performing general control over the navigation application. The traffic information processor 3004 functions to manage and update traffic information downloaded from the navigation server 102 and statistical traffic information stored in the memory card 201, and so on. The route/guidance information processor 3005 functions to execute route guidance, manage the position of the own car and so on. The map information processor 3006 mainly manages map information. When a map is downloaded, the map information processor 3006 plays a role of storing the map according to the directory configuration of an area for storage of the map of the memory card 201.

The application control 3002 of the controller 3001 is a module for determining a processing flow of the navigation application. This module plays a role of deciding various events generated in the car-mounted terminal 106 and executing the corresponding processing according to the decided result. The display control 3003 is a module for playing a role of changing a display method according to the information type. The module provides different colors according to components included in the map or to congestion degrees included in the traffic information. Further, the module provides different display methods between the data received by the beacon receiver 407 and the statistical traffic information. For example, a normal display method is employed for the data received by the beacon receiver 407, while color is made thin or flashed for the statistical traffic information to explicitly display the statistical data. The above selective employment is also controlled. For example, the selective employment control is made in such a manner that traffic information received at the beacon receiver 407 is displayed for a location close to the position of the car; whereas, traffic information based on statistics is displayed for a location away by a predetermined distance from the car position.

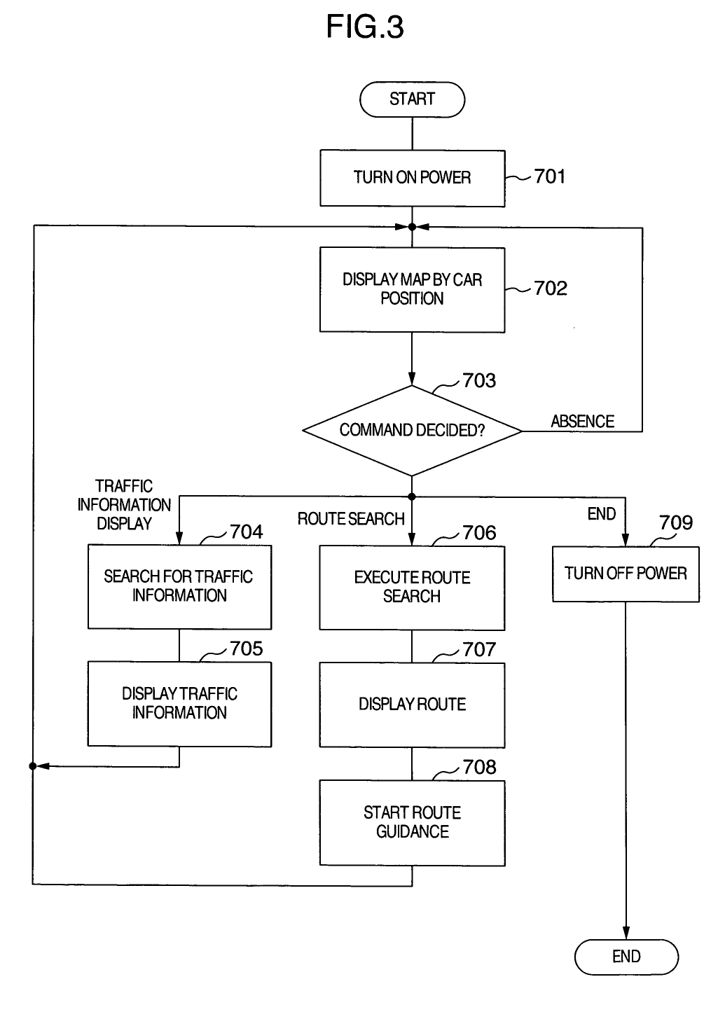

FIG. 3 shows a processing flow of operations of the car-mounted terminal 106. When an engine switch of the user vehicle 111 is first turned ON, the power of the car-mounted terminal 106 is turned ON (step 701). In the power ON state, the GPS receiver 406 measures the position of the car and a map around the position of the car is displayed (step 702). Thereafter, the terminal decides a command entered by the user via the remote controller 405 (step 703), and executes its operation according to the command. Although route search and traffic information display are disclosed in FIG. 3, other commands may be used as a matter of course.

When the command entered by the user is for the traffic information display, the terminal executes its searching operation for traffic information in a step 704 and displays the searched traffic information (step 705). With regard to the searching operation of the step 704 for the traffic information, the traffic information stored in the car-mounted terminal 106 may be used as its search target or the traffic information may be searched for by the navigation server 102. With respect to the place from which the traffic information is acquired, the place may be decided according to the enabled or disable communication state of the car-mounted terminal 106.

When the command from the user is for route search, the terminal executes its route searching operation and displays its obtained route (step 707). Thereafter, the terminal starts the route guidance (step 708). With respect to the route search, the route search is required by the navigation server 102 or is executed by the route search engine (not shown) built in the car-mounted terminal 106.

When the user's command is a termination command, this causes the power of the car-mounted terminal 106 to be turned OFF, thus terminating the system. Or even when the engine switch of the user vehicle 111 is turned OFF, the system terminates. When the system terminates, the route information and traffic information obtained so far are stored in the car-mounted terminal 106 and remain therein.

As a means for acquiring traffic information, the present embodiment shows how to receive it from the beacon 114, how to receive it from the navigation server 102, and how to load data previously stored in the memory card 201. As another means, it is considered to receive data distributed from the broadcast provider 105.

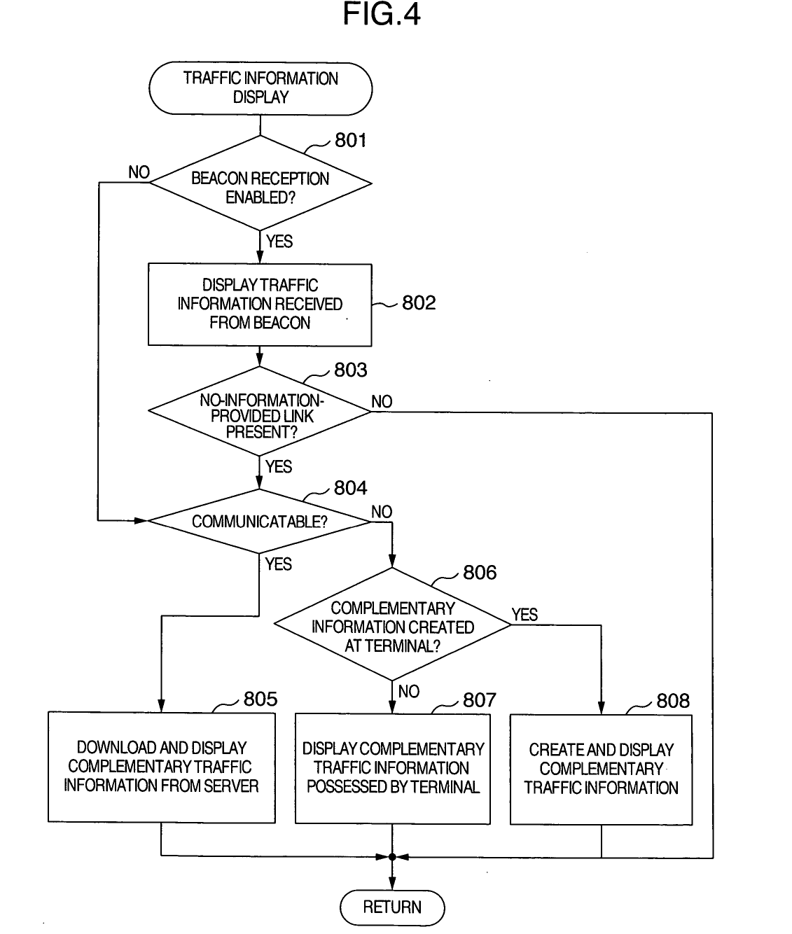

FIG. 4 is a flow chart showing a series of flows from acquisition of traffic information to its display, corresponding to the operations of the steps 704 and 705 in FIG. 3. Shown in FIG. 4 is an example wherein data received by the beacon receiver 407, data acquired by communication, and data stored in the memory card 201 are combined and used. The flow chart shows, in particular, when the data obtained by the beacon receiver 407 is preferentially used. Of course, either of the data acquired by communication and the data stored in the memory card 201 may be preferentially used.

The car-mounted terminal 106 decides whether or not the beacon receiver 407 is in its receivable mode (step 801). More specifically, the terminal decides whether or not information from the beacon 114 is distributed to the vicinity of the car position and whether or not the beacon receiver 407 is normally operated. If the beacon receiver 407 can receive information, then the beacon displays the information received thereby (step 802). The obtained information includes at least travel times and congestion degrees of road links. Since there is possibly a link having no information (which will be referred to as no-information-provided link, hereinafter), however, the terminal decides the presence or absence of such a no-information-provided link after obtaining the data (step 803). If there is a no-information-provided link as a decision result, then the terminal complements the information of the no-information-provided link.

There are two methods of complementing the information of the no-information-provided link, that is, one of which is to download the data being created by the navigation server 102 at intervals of a constant time and the other is to compute and complete information by the car-mounted terminal 106. Thus, the terminal decides whether or not to able to communicate with the navigation server (step 804). If communicatable, then the terminal downloads complementary data from the navigation server 102 and displays it (step 805). If uncommunicatable, then the terminal selects one of methods for creating complementary data at the car-mounted terminal 106 and using the data stored in the memory card 201 (step 806). When the complementary data is created by the car-mounted terminal 106, the terminal proceeds to a step 808; whereas, when the data stored in the memory card 201 is used, the terminal goes to a step 807, displaying these data respectively.

In creating traffic information statistical data in the traffic information server 302, past traffic information is previously acquired and initial statistical data is created using the past data, as a preparation before the traffic information server 302 is operated. This operation is carried out offline.

The operation to be carried out offline is provided in the form of a resident program which waits for the data from the traffic information center 113. The program confirms whether or not to have received the data at intervals of a constant time and waits for the traffic information from the traffic information center 113. And when confirming the coming of the data from the traffic information center 113, the program performs its data receiving operation. Simultaneously with the data reception, the data received from the traffic information center 113 is stored in the interior of the navigation server 102. This is for the purpose of coping with not the situation when the car-mounted terminal 106 acquires traffic information from the beacon receiver 407 but the situation when the terminal the traffic information acquires traffic information by communication. When the traffic information is stored, it is converted to a distribution format and then stored as a file.

In the present embodiment, statistical data of the traffic information is successively updated and the update timing is decided. At the timing of updating the statistical data, the statistical data is updated. After the updating, the terminal again waits for the reception of data from the traffic information center 113. The same holds true even when no updating is carried out and only when the data reception is carried out. The update timing of the statistical data is arbitrarily set by the system administrator. The timing may be set to be, for example, on every other day, on every other week, on every other month, and so on. When the load of data from the traffic information center 113 on the traffic information server 302 looks large, the server does not process the data online but merely receives the data from the traffic information center 113 for its buffering. And when the update timing comes, the server may create statistical data offline.

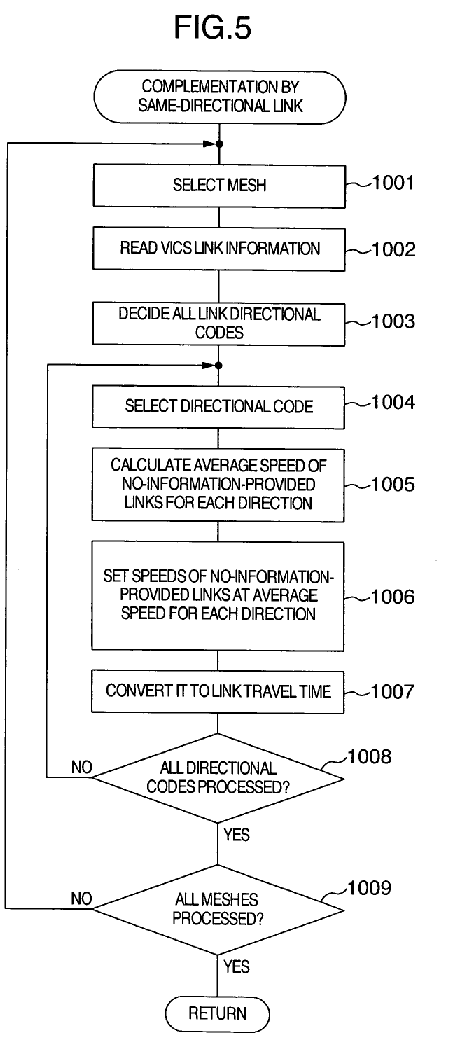

Explanation will then be made as to embodiments of an algorithm of providing information to a no-information-provided link. FIG. 5 shows a first example. In FIG. 5, the directional code of each link is determined, an average speed is found for each directional code, and the average speed is converted to a link travel time.

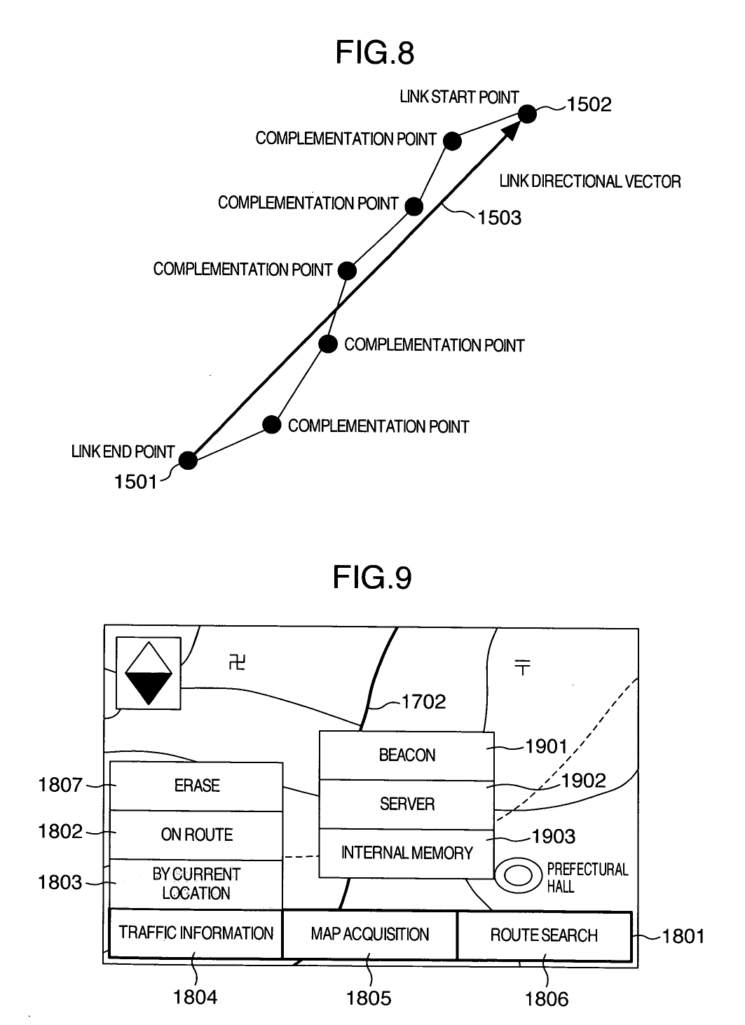

First, there is a loop to process all target meshes (steps 1001 to 1009). The algorithm reads traffic information about one of the target meshes selected in the step 1001 (step 1002). The algorithm next decides directional codes of all links in the mesh including a no-information-provided link (step 1003). The directional code is allocated to any one of eight directions, for example, east E, west W, south S, north N, northeast NE, northwest NW, southeast SE, and southwest SW. In the present embodiment, “direction” indicates the direction of a vector 1503 directed from a link start point 1501 to a link end point 1502, as shown in FIG. 8. After the directional code is decided, the speeds of information-provided ones of links included in each directional code are first found. The speed is a value obtained by dividing a link length by a link travel time provided. After finding the speeds for the links, the algorithm finds an average value of the speeds of the information-provided links (step 1005), sets the average value as the speed of the no-information-provided link in the code (step 1006), converts it to a link travel time, and sets it as the link travel time of the no-information-provided link (step 1007). All the above operations are carried out for all the directional codes (step 1008). When the operations of all the meshes are completed, the complementation of all the no-information-provided links is terminated.

Explanation will be made as to the processing when complementation is carried out by referring to information about several information links close in distance to a no-information-provided link, as a second example. In the second embodiment, operations similar to the first example are carried out until the directional code deciding operation of the step 1003 in the first example. Next, the algorithm searches for information-provided links close in distance to no-information-provided links included in each directional code, and finds an average of the speeds of the searched information-provided links. A distance between links (interlink distance D) is defined a distance in midpoint between the links. When the coordinate point of a link midpoint is not present in a link, a complementation point closest to the link midpoint is used as the link midpoint. A threshold value for use in decision of whether or not a distance between links is small is previously set or entered on the display screen (not shown) by the user. The computed average speed is used as the link speed of the no-information-provided link.

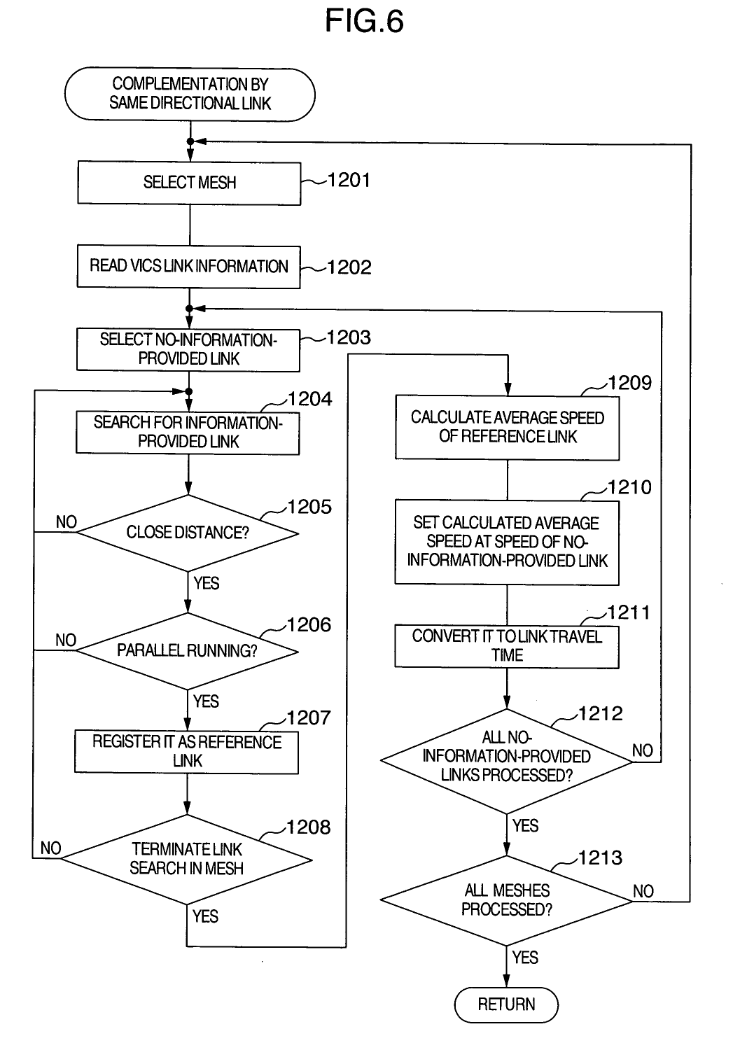

FIG. 6 is a flow chart of operations in a third example. Although the complementary data is first found in the first and second examples, a directional code is not used and complementation is carried out using information about links having a close interlink distance and extended parallel to each other in the third example. First, the algorithm reads traffic information about links of a target mesh (step 1202). Next, there is a processing loop for all no-information-provided links in the target mesh (steps 1203 to 1212), and the algorithm complements a no-information-provided link for each mesh. The algorithm first searches for a information-provided link in the mesh, decides whether or not the searched information-provided link is close in distance to the no-information-provided link (step 1205), and decides whether or not the searched information-provided link runs nearly parallel to the no-information-provided link (step 1206). If the above decisions are both YES, then the information-provided link is registered as a reference link (step 1207). A threshold value for use in the decision of whether or not the searched link is close to the no-information-provided link in the step 1205 is previously set or entered on the display screen (not shown) by the user. Thereafter, the algorithm decides whether or not to have searched for all the information-provided links in the mesh (step 1208). After the search, the algorithm finds an average speed of links registered as reference links (step 1209). The algorithm converts the computed average speed to a link travel time (step 1210) and uses it as the link travel time of the no-information-provided link (step 1211). The algorithm performs the above operations on each no-information-provided link and creates complementary data about all the no-information-provided links in the mesh.

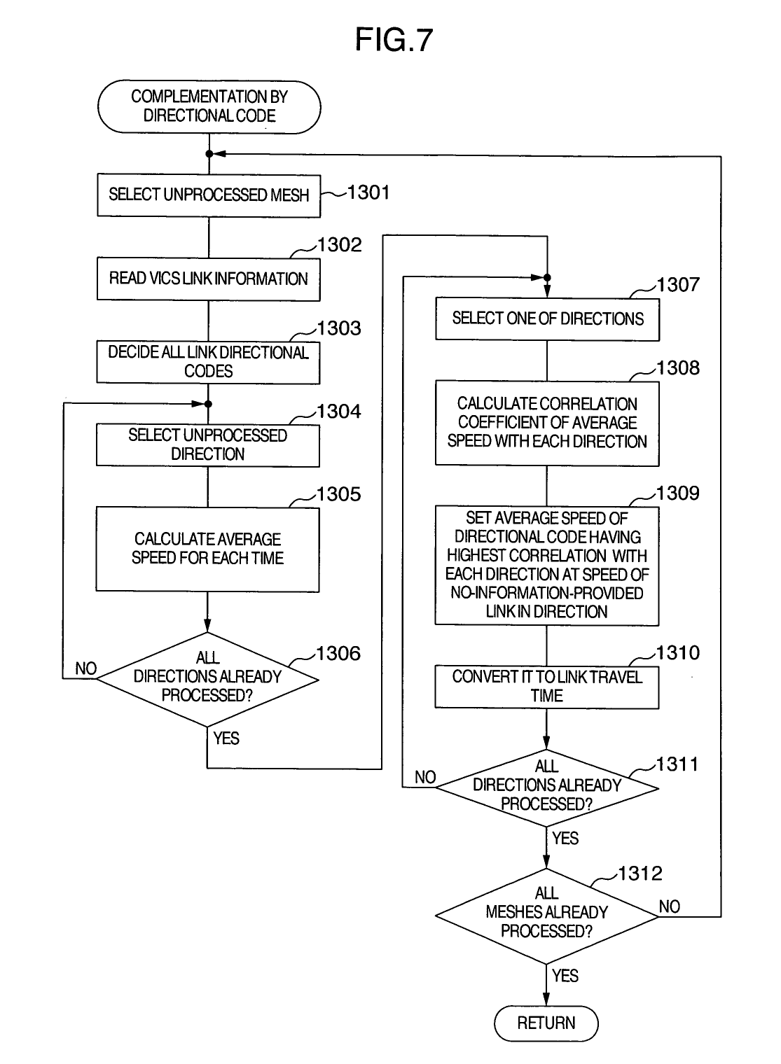

FIG. 7 is a flow chart of a fourth example. In the fourth embodiment, a no-information-provided link is complemented using a correlation between directional codes. The algorithm first reads link information including traffic information for each mesh (step 1302), and a directional code for each link (step 1303). The algorithm calculates an average speed for each time point for each directional code (step 1305). After that, the algorithm again enters into a loop for each directional code and calculates the directional code and a correlation coefficient for the speed (step 1308). The algorithm sets each time average speed for a directional code having the highest correlation coefficient as a time average speed for each no-information-provided link in the directional code (step 1309). The algorithm finally converts the time average speed to a link travel time (step 1310) and sets the converted link travel time as each time link travel time in the directional code.

FIG. 9 is an example of a menu display screen of the car-mounted terminal 106. When the power of the car-mounted terminal 106 is turned ON, a map in the vicinity of the position of the car appears on the screen. A mark indicative of the car position is given in the center of the screen. And when the car is running along a route 1702, the route appears on the screen. In this condition, the operation of the remote controller 405 causes a menu 1801 to appear on the screen. In the present embodiment, a traffic information menu 1804, a map acquisition menu 1805, and a route search menu 1806 are displayed. From these menus, when the traffic information menu 1804 is selected, an on-route menu 1802 and a current position vicinity menu 1803 appears. When the user specifies any one of the on-route menu 1802 and the current position vicinity menu 1803, the car-mounted terminal 106 displays traffic information according to the flow chart of FIG. 4. At this time, the terminal is designed so that, after the user selects the on-route menu 1802 or the current position vicinity menu 1803, such a menu as to select information acquiring methods appears, whereby the user can select one of the information acquiring methods.

In FIG. 9, the information acquiring methods include a beacon menu 1901, a server menu 1902, and an internal memory menu 1903. When the user selects the beacon menu 1901, traffic information received at the beacon receiver 407 appears. When the user selects the server menu 1902, the terminal accesses the navigation server 102, receives statistical traffic information stored in the traffic information server 302, and displays it. The selection of the internal memory menu 1903 causes statistical traffic information stored in the memory card 201 to appear.

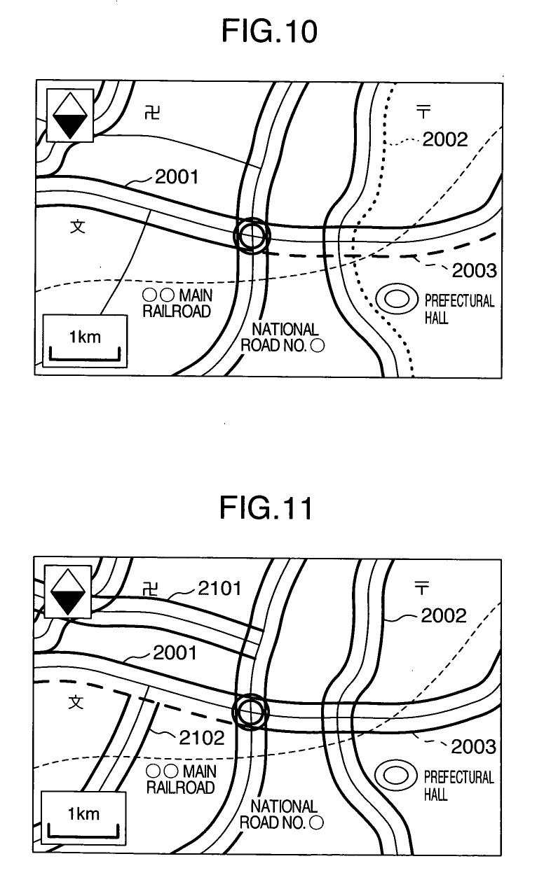

An example of the screen displaying traffic information is shown in FIG. 10. FIG. 10 shows data received at the beacon receiver 407, which does not necessarily provide traffic information about all road links. Numerals 2001, 2002, 2003, etc. given by roads indicate congestion information. The numerals are shown by solid and dotted lines to distinguish a degree of congestion between “congested”, “heavy”, and “smooth”. In actual systems, however, the congestion degree is distinguished usually by color. The method for displaying such congestion information may be varied by considering only the congestion degree regardless of the information acquiring methods, or may be varied by also considering the information acquiring methods.

When the terminal performs complementing operation on no-information-provided links received at the beacon receiver 407, the terminal can provide traffic information about all links. Whether or not to perform the complementing operation can be previously set by the car-mounted terminal 106 or can be selected by the user on the basis of a menu displayed when the terminal receives the no-information-provided links. Or the user can again display the menu 1201 from the state of the screen of FIG. 10 and select the traffic information menu 1804. If the user selects the current position vicinity menu 1803 when traffic information is displayed, then a menu for selecting the information acquiring methods appears as shown in FIG. 9.

As mentioned above, when the user wants to display traffic information under a condition that traffic information is displayed, the menu for selecting the information acquiring methods appears and the terminal displays traffic information available by the selected method. It is also possible not to display the menu, previously give a priority order, and acquire it according to the priority order, as a matter of course. However, when traffic information is displayed and the user selects the traffic information menu 1804, it is also considered for the user to want to acquire information different from the traffic information being currently displayed. For this reason, it is desirable to display the menu.

If the user wants to erase the traffic information, then he selects an erase menu 1807. This causes the traffic information to be erased. It is desirable that the erase menu 1807 not appear on the screen so as not to be selected when the traffic information is not displayed.

FIG. 11 shows an example where the user selects one of the information acquiring methods in the state of FIG. 10 to display traffic information. In the example of FIG. 11, data about the memory card 201 is displayed or data about the traffic information server 302 is displayed. Such a message as to tell “server traffic information will be downloaded” first appears on the screen to inform the user of the information acquiring method, and thereafter traffic information appears. Information is provided even to a no-information-provided link which failed to acquire information in FIG. 10, and there is also present such a link as different from the information received at the beacon receiver 407. For example, the numerals 2002 and 2003 have different pieces of congestion degree information, that is, have statistical information different from the current information received at the beacon receiver 407. The information 2101 or 2102 is for a no-information-provided link when received at the beacon receiver 407, but is for the traffic-information-provided link when the statistical traffic information is displayed. In other words, complemented data is displayed.

The message telling the user the information acquiring methods may be designed to be displayed necessarily before the traffic information is displayed. For example, when the data of the memory card 201 is displayed, such a character string as “terminal information will be displayed” appears; whereas, such a character string as “beacon data will be displayed” appears when the data received at the beacon receiver 407 is displayed.

In this connection, the statistical traffic information downloaded from the navigation server 102 may be stored in the memory card 201 or be discarded at suitable timing. For example, a threshold value can be previously set for a time after the car runs out of the displayed route or a run distance away from the displayed car route, and the statistical traffic information can be discarded based on the threshold value.

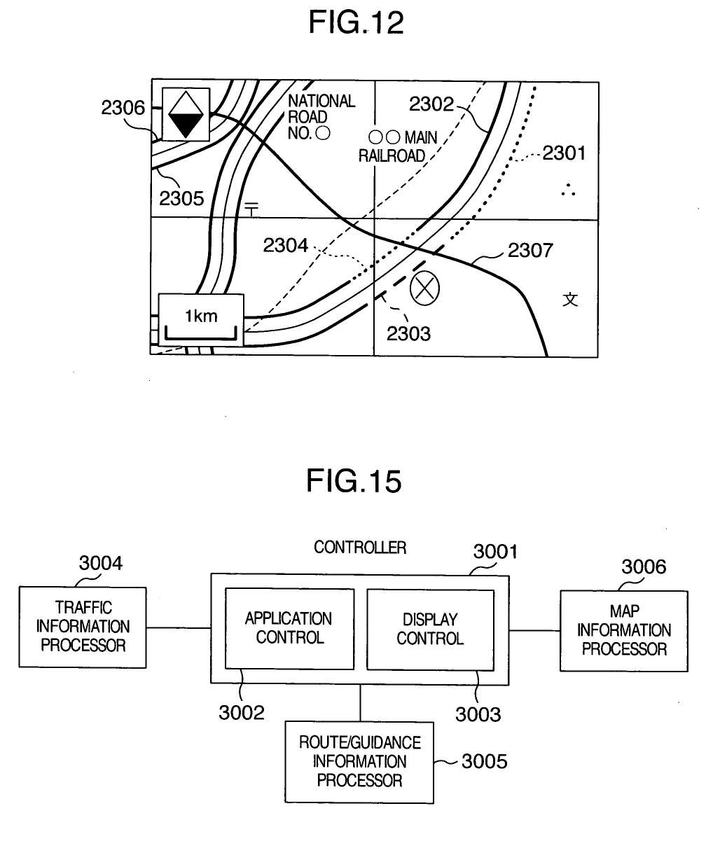

Explanation will next be made as to an embodiment wherein statistical traffic information is downloaded together with a route. In a route search mode, the car-mounted terminal 106 accesses the search/guidance server 303 and downloads route data therefrom. If the car-mounted terminal 106 has a route search engine (not shown), however, then the terminals does not access the search/guidance server 303 but uses the route search engine of the car-mounted terminal 106. When completing the route search, the terminal displays such a screen as shown in FIG. 12. At this time, after the route data is displayed, statistical traffic information about the vicinity of the route is downloaded together with the route data from the navigation server 102 and displayed. In the screen of FIG. 12, congestion information 2302, 2303, 2304, 2305, and 2306, which have not been displayed on the screen before the route search, appear. The congestion information 2301 is information obtained after the information stored in the car-mounted terminal 106 is updated. For example, when the car-mounted terminal 106 has only the data received at the beacon receiver 407, the terminal downloads the statistical traffic information from the CGI server 301 and overwrites it on the data. When the terminal has both the information received at the beacon receiver 407 and the statistical traffic information of the CGI server 301, however, the former may be preferentially displayed, in which case the display of the congestion information 2301 will not be changed. It is desirable that the car-mounted terminal 106 previously determine one of the both information to be preferentially displayed.

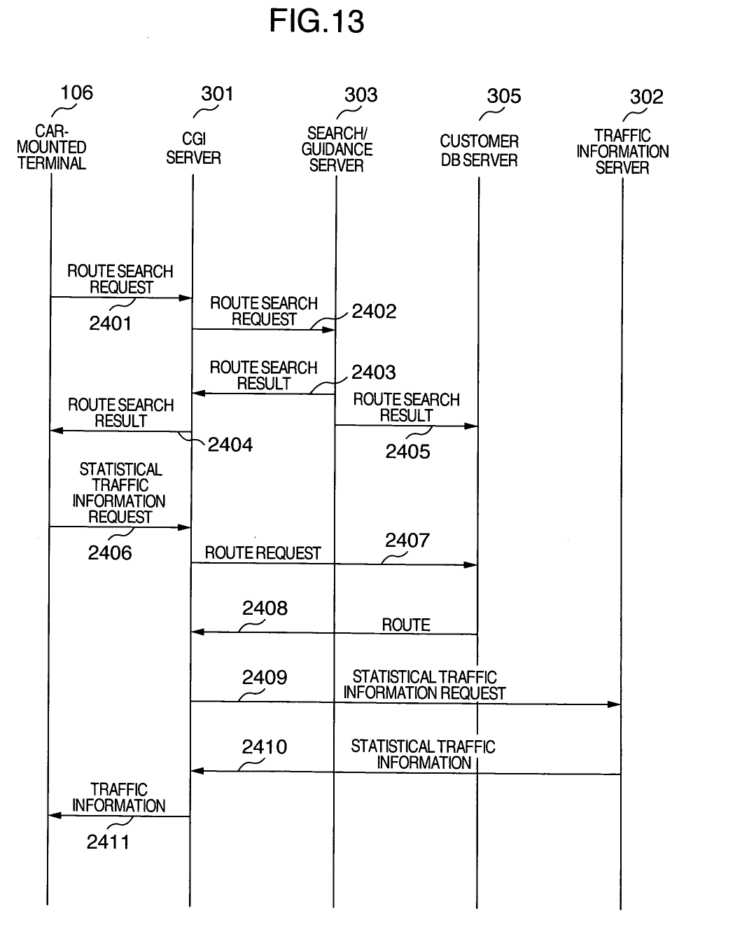

FIG. 13 is a sequence chart when route data and statistical traffic information are downloaded. The car-mounted terminal 106 transmits a route search request to the CGI server 301 together with the car position, a goal point, and search conditions (step 2401). The CGI server 301 transmits the route search request to the search/guidance server 303 together with the car position, the goal point, and the search conditions (step 2402). And the search/guidance server 303 in turn performs its route searching operation according to the received conditions. When completing the route search, the search/guidance server 303 returns route data to the CGI server 301 (step 2403), and the CGI server 301 in turn returns the route data to the car-mounted terminal 106 to the car-mounted terminal 106 (step 2404). The CGI server 301 also registers the route data in the customer DB server 305 (step 2405).

The car-mounted terminal 106, after receiving the route data, accesses the CGI server 301 and requests statistical traffic information (step 2406). The CGI server 301 acquires route information already stored in the customer DB server 305 to decide a range of statistical traffic information to be transmitted (steps 2407 and 2408). The CGI server 301 decides the range by referring to the route information and requests the traffic information server 302 to send statistical traffic information (step 2409). The CGI server 301 receives the statistical traffic information from the traffic information server 302 (step 2410) and returns it to the car-mounted terminal 106 (step 2411).

Although the range of the statistical traffic information is determined by referring to the route information in the present embodiment, the car-mounted terminal 106 may transmit its desired range. At this time, the need for executing the operations of the steps 2407 and 2408 can be eliminated.

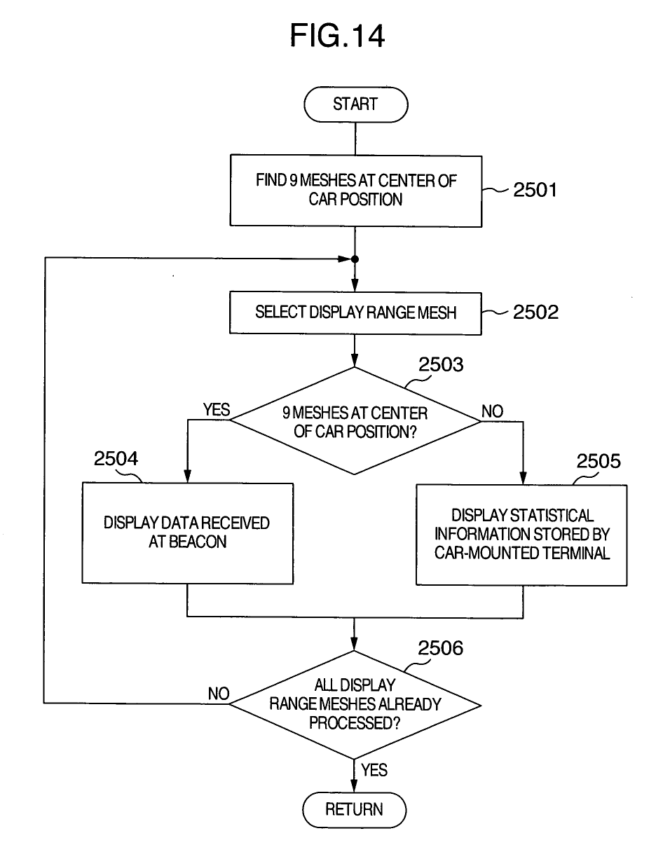

Another embodiment of displaying traffic information will be shown. FIG. 14 is a flow chart of operations to decide whether the reception result of the beacon receiver 407 or statistical traffic information is to be displayed. This is designed so that the reception result of the beacon receiver 407 is displayed in a zone close to the car position, and the statistical traffic information is displayed in a zone away from the car position. In the flow chart, it is assumed that meshes in a range to be previously displayed are already determined. For example, meshes are previously determined to be in the range to be displayed on the screen.

A loop for processing all meshes in the display range is present (steps 2502 to 2506) and the terminal decides whether or not each of the meshes is in the vicinity of the car position (step 2503). In the present embodiment, the word “the vicinity of the car position” is defined as “within 9 meshes in the vicinity of the car position”. In many cases, traffic information is controlled or managed on a mesh basis. Thus when the display is also carried out on mesh basis, the display can be easily implemented. In this conjunction, the “the vicinity of the car position” may be defined as “within an ‘n’ kilometer from the center of the car position” or as “25 meshes” without limiting to 9 meshes, or as “only 1 mesh”.

With regard to meshes decided to be within the vicinity of the car position, the result received at the beacon receiver 407 is displayed (step 2504). With regard to meshes decided otherwise, the statistical traffic information is displayed (step 2505).

However, when only the data received at the beacon receiver 407 is displayed, a no-information-provided link has no information still. Thus with respect to the no-information-provided link, the statistical traffic information may be displayed.

Explanation will then be made as to how to switch between the display of traffic information received from the navigation server 102 and the display of estimated traffic information data stored in the terminal. When the car-mounted terminal 106 receives the traffic information received from the navigation server 102, the traffic information will not be updated so long as a request is not issued from the terminal thereto. For this reason, when the car-mounted terminal 106 does not issue the request for a long period of time, old traffic information is continuously displayed. To avoid this, an expiration time is previously set for the traffic information received from the navigation server 102. The traffic information including the expiration time data is made up of a data header, data body and a terminating flag; and the data header contains an acquisition date, an acquisition time and an expiration time. When the traffic information is decided that its expiration time went by after its download, the statistical traffic information stored in the car-mounted terminal 106 is displayed. In this connection, the expiration time may not be included in the data and set by the car-mounted terminal 106. In this case, the expiration time may be stored in the car-mounted terminal 106 as a fixed value or may be set on the screen by the user.

During the appearance of the downloaded traffic information on the display screen, when it is decided that the time set as an expiration time went by, a message telling “estimated traffic information data will be displayed based on the statistical data stored in the car-mounted terminal 106” appears on the screen. Thereafter, the terminal erases the display of the downloaded traffic information having the expired expiration time and displays the estimated traffic information data, whereby the display of the traffic information is switched. In this case, part of the estimated traffic information data different from the data downloaded from the navigation server 102 will be changed and displayed, as a matter of course.

The present embodiment is arranged so that the user can specify his one of countries for the display method. This is for the purpose of considering different cultures different upon different countries. When the user operates the remote controller 405 to display a screen 2901 of display setting, a list of countries appears. When the display mode is JAPAN, for example, “congested”, “heavy”, and “smooth” are displayed with colors red, yellow and green respectively. For other countries, display colors suitable for their cultures are employed.

When traffic information is suitably provided to the user of the car navigation system using the system, the present invention can exhibit good effects.

It should be further understood by those skilled in the art that although the foregoing description has been made on embodiments of the invention, the invention is not limited thereto and various changes and modifications may be made without departing from the spirit of the invention and the scope of the appended claims.

1. A traffic information display apparatus comprising:
a position measuring unit measuring a position of a own terminal;
a traffic information acquiring unit acquiring traffic information;
a memory unit storing traffic statistical information;
an estimating unit estimating traffic information relating to a link not included in the traffic information acquired by said traffic information acquiring unit; and
a display control unit changing a traffic information display method according to whether or not the traffic information acquired by said traffic information acquiring unit is estimated data,
wherein said display control unit displays the traffic information acquired by said traffic information acquiring unit when traffic information about a location close to the position of said own terminal, and displays the traffic information based on traffic statistical information stored in said memory unit when the traffic information about a location away from the position of the own terminal.

2. A traffic information display apparatus according to claim 1, wherein said estimating unit, when estimating the traffic information relating to a link not included in the traffic information acquired by said traffic information acquiring unit, estimates the traffic information on the basis of traffic information about ones of links directed in same direction within a mesh including a link which have the traffic information.

3. A traffic information display apparatus according to claim 1, comprising a display setting unit for accepting the traffic information to decide the traffic information displaying method.

4. A traffic information display apparatus comprising:
a position measuring unit measuring a position of an own terminal;
a traffic information acquiring unit acquiring traffic information;
a communication unit transmitting and receiving data to and from an information center; and
a memory unit storing traffic statistical information,
wherein said communication unit acquires a link not included in the traffic information acquired by said traffic information acquiring unit from said information center,
said traffic information displaying apparatus further comprising:
a display control unit changing a traffic information display method according to the traffic information acquired by said traffic information acquiring unit and according to the traffic information relating to a link not included in the traffic information estimated by an estimating of said information center acquired by an said communication unit and acquired by said traffic information acquiring unit,
wherein said display control unit displays the traffic information acquired by said traffic information acquiring unit and the traffic information by said estimating unit when the traffic information about a location close to the position of said own terminal is displayed, and displays the traffic information based on the traffic statistical information stored in said memory unit when the traffic information about a location away from the position of the own terminal is displayed.

5. A traffic information display apparatus according to claim 4, wherein said estimating unit, when estimating the traffic information relating to the link not included in the traffic information acquired by said traffic information acquiring unit, estimates the traffic information on the basis of traffic information about ones of links directed in a same direction within a mesh including the link which have the traffic information.
